(19) United States
(12) Patent Application Publication
(10) Pub. No.: US 2009/0014903 A1
(43) Pub. Date: Jan. 15, 2009

(54) METHOD OF MAKING FOAMING MEMBER WITH HETEROGENEOUS COMPOSITE FOAMING LAYERS

(76) Inventor: Semi KAO, Chang-Hua Hsien (TW)

Correspondence Address: SINORICA, LLC, 528 FALLSGROVE DRIVE, ROCKVILLE, MD, 20850, US

(21) Appl. No.: 11/829,893

(22) Filed: Jul. 28, 2007

(30) Foreign Application Priority Data
Jul. 13, 2007 (TW) 96125686

(51) Int. Cl. B29C 43/30

(52) U.S. Cl. 264/46.5

(57) ABSTRACT

The present invention provides a method of making a foaming member with heterogeneous foaming layers. The first step is adding a foaming agent and an accelerator to a first material, which is a flexible material, and a second material, which is a non-flexible material, respectively, and then pressing and stirring the first material and the second material respectively for well mix. The second steps is pressing the first material and the second material respectively to form a first material piece and a second material piece. The third step is stacking the first material piece and the second material piece to form a stack. The fourth steps is vulcanizing the stack in a high pressure and high temperature environment to bond the first material piece and the second material piece together firmly; and the last step is releasing pressure on the stack to get a foaming member.

### BACKGROUND OF THE INVENTION

1. Field of the Invention

The present invention relates generally to a method of making foaming members, and more particularly to a method of making a foaming member with heterogeneous foaming layers.

2. Description of the Related Art

Conventional methods of making a rubber foaming member, natural robber or artificial rubber, are classified into two categories, hot pressing and continuous extrusion. Hot pressing method includes the step of pressing a die with rubber material therein for heating and pressing to make the rubber foaming member. Continuous extrusion includes the step of extruding the rubber material by an extruder and rolling it to form a continuous rubber film, and then the rubber film is sent to a box for vulcanization to form a foaming member.

For a requirement of a variety of products, the rubber foaming member of single material is out of the market. Some rubber foaming members are attached with a skin layer of heterogeneous material to provide a fancy look, extra functions, or other purposes that consumers may have greater willing to buy them. For the technique of rubber foaming member attached with skin layer, a conventional method includes the steps of coating adhesive on the rubber material to attach the skin layer thereon, and then the stack is sent for vulcanization.

Aforesaid method is incorporated with adhesive that may cause air or water pollution.

### SUMMARY OF THE INVENTION

The primary objective of the present invention is to provide a method of making a foaming member with heterogeneous foaming layers, which has no adhesive to attach the layers together.

According to the objective of the present invention, a method of making a foaming member with heterogeneous foaming layers includes the steps of: adding a foaming agent and an accelerator to a first material, which is a flexible material, and a second material, which is a non-flexible material, respectively, and then pressing and stirring the first material and the second material respectively for well mix; pressing the first material and the second material respectively to form a first material piece and a second material piece; stacking the first material piece and the second material piece to form a stack; vulcanizing the stack in a high pressure and high temperature environment to bond the first material piece and the second material piece together firmly; and releasing pressure on the stack to get a foaming member.

The present invention further provides another method including the steps of: adding a foaming agent and an accelerator to a first material, which is a flexible material, and a second material, which is a non-flexible material, respectively, and then pressing and stirring the first material and the second material respectively for well mix; pressing the first material and the second material respectively to form a first material piece and a second material piece; stacking the first material piece and the second material piece to form a stack; vulcanizing the stack in a high pressure and high temperature environment to bond the first material piece and the second material piece together firmly; and releasing pressure on the stack to get a foaming member.

### BRIEF DESCRIPTION OF THE DRAWINGS

FIG. 1 is a flow chart of a first preferred embodiment of the present invention;

FIG. 2 is a perspective view of a foaming member made by the method of the first preferred embodiment of the present invention;

FIG. 3 is a perspective view of another foaming member made by the method of the first preferred embodiment of the present invention;

FIG. 4 is a flow chart of a second preferred embodiment of the present invention; and

FIG. 5 is a flow chart of a third preferred embodiment of the present invention.

### DETAILED DESCRIPTION OF THE INVENTION

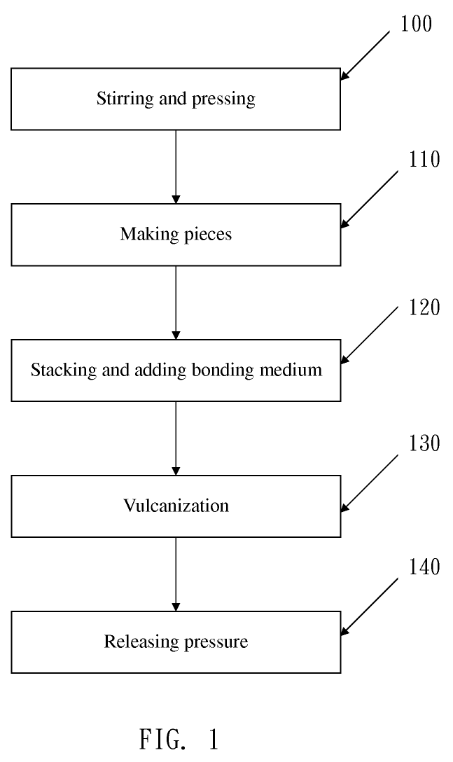

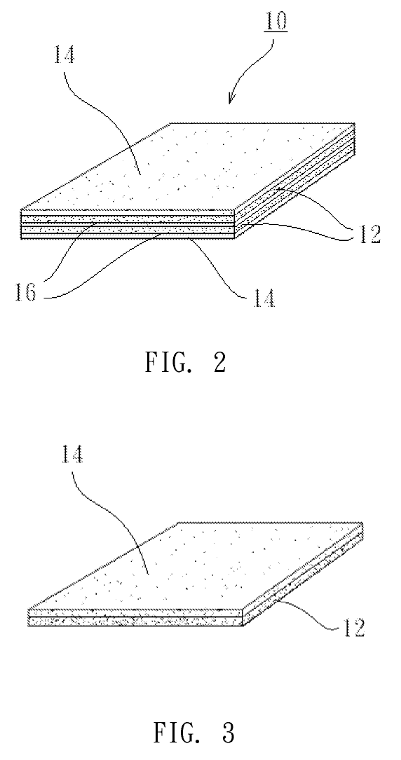

As shown in FIG. 1 and FIG. 2, a method of making a foaming member 10 of the preferred embodiment of the present invention includes the following steps:

The first step 100 is stirring. A first material and a second material are added with foaming agent and accelerator respectively, and then the first and second materials are stirred and pressed repeatedly in stirring machine respectively. Next, the first and second materials are sent to mixing machine for another mixing process.

In the present invention, the first material is a flexible foaming material, such as thermoplastic rubber (TPR), and the second material is a non-flexible foaming material, such as polyethylene (PE). The foaming agent is an organic foaming agent, such as azobisformamide (ADCA), and the accelerator is a rubber vulcanization accelerator, such as TMTD and MBT. The first and second materials are added with sulfur donor agent (such as sulfur) and fillet (such as reinforcing agent) and other agent for reduction cost and improvement the physical properties (such as rubber grade carbon black, fumed silica, calcium silicate (CaSiO₃), and calcium carbonate (CaCO₃) respectively. The first and second materials may be added with different colors.

The second step 110 is pressing the first and second materials into piece-like members by specific machine.

The third step 120 is stacking the first material pieces 12 and second material pieces 14 alternately and adding a bonding medium 16 therebetween to form a stack.

The bonding medium 16 may be a thermoplastic elastomer (TPE). The thermoplastic elastomer includes different flexible plastics of a series. In the present invention, the bonding medium 16 is styrenic block copolymer (SBC), which includes a constituent that may bond to the first and second materials 12, 14 respectively. The bonding medium 16 may be added with color as same as the first or second materials 12, 14.

The fourth step 130 is vulcanization in a high temperature and high pressure environment. The stack, with the first material pieces 12, the second material pieces 14 and the bonding medium 16, is put in a die for vulcanization in a high temperature and high pressure environment that the bonding medium 16 may bond the first material pieces 12 and the second material pieces 14 together firmly.

The fifth step 140 is release of pressure and opening the die in a predetermined time that a foaming member 10 with different foaming layers (the first and second materials 12, 14) will be formed, as shown in FIG. 2.

The machines and devices used in aforesaid steps are the common tools used in the process of making the foaming member, and they are not involved in the main characters of the present invention, so we won't describe their detail here.

Therefore, the present invention uses the gas pressure generated in the chemical reaction of vulcanization to bond the heterogeneous first and second material 12, 14 together that no adhesive is added in the present invention to cause pollution.

In the present invention, the first material 12 may be a flexible material, and the second material 14 may be a soft and skid proof material that the foaming member 10 made by the method of the present invention may have all functions of soft, support, cushion, shock absorption, and skid proof, such a foaming member is preferred for sport pad, sole of shoes and the like. FIG. 3 shows a Yuga pad made by the method of the present invention, which has a first foaming material 12 and a second foaming material 14. The second foaming material 14 is on a top of the Yuga pad, which is soft to provide the user a comfortable touch, and the first foaming material 12 is under the second foaming material 14, which has no ductility and malleability to prevent the Yuga pad from deformation while user takes Yuga thereon.

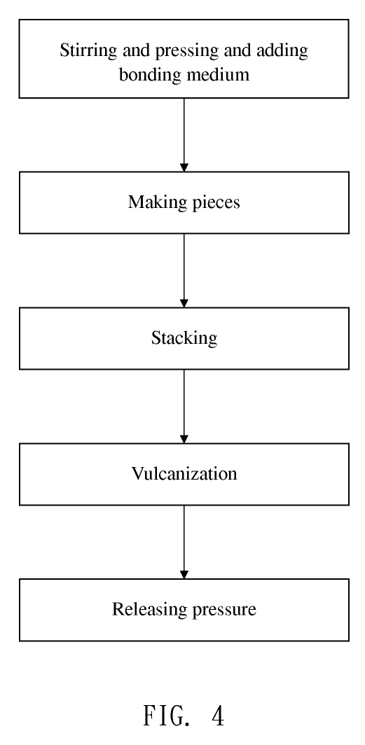

FIG. 4 shows a flow chart of a method of the second preferred embodiment of the present invention, which is similar to the method of the first preferred embodiment, except that the bonding medium is added in the first material and the second material respectively that will make the first material and the second material, which cannot bond together inherently, may bond together in the following vulcanization step. The bonding medium may be any chemical compound that may make the first material and the second material bonding in the vulcanization step except for adhesive.

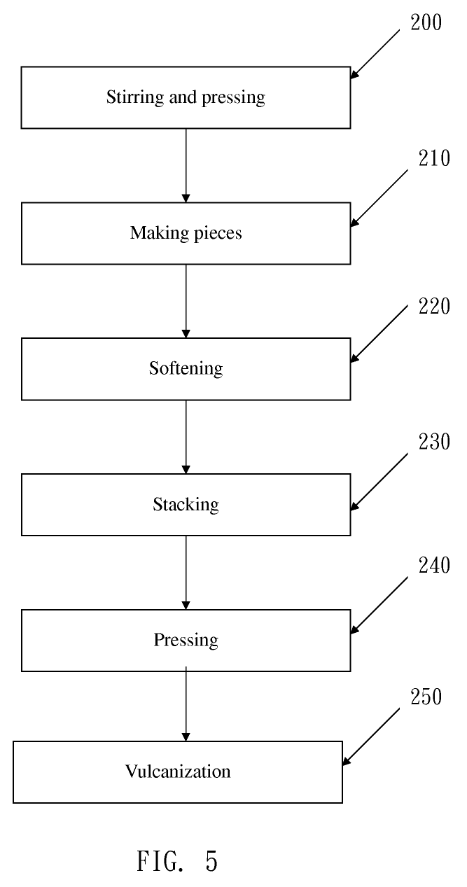

FIG. 5 shows a flow chart of a method of the third preferred embodiment of the present invention, which is a continuous fabricating method. The first step 200 is mixing, in which the first material and the second material are mixed with foaming agent and accelerator in a predetermined ratio respectively, and they are stirred and presses for well mix.

The second step 210 is pressing first and second materials into piece-like members by specific machine.

The third step 220 is softening. A softener is coated on the first material and the second material, and then the first material and the second material are heated to 150° C. to 250° C. for softening the first material and the second material. The softener is a common agent using in the process of making rubber products. The softening step 220 may be replaced by exposing the first material and the second material under infrared rays to soften the surfaces thereof.

The fourth step 230 is stacking the first material pieces and the second material pieces alternately to form a stack.

The fifth step 240 is pressing the stack by a rolling device.

The sixth step 250 is vulcanization. The stack, with the first material pieces and the second material pieces, is put in a die for vulcanization in a high temperature and high pressure environment that the first material pieces 12 and the second material pieces 14 are bonded together firmly to form a foaming member.

The last step is cooling the foaming member to room temperature and rolling it on a reel.

In conclusion, the method of the present invention may make a foaming member with heterogeneous foaming layers and no adhesive is added in the process that will not cause pollution.

The description above is a few preferred embodiments of the present invention and the equivalence of the present invention is still in the scope of the claim of the present invention.

What is claimed is:

1. A method of making a foaming member with heterogeneous foaming layers, comprising the steps of:
adding a foaming agent and an accelerator to a first material, which is a flexible material, and a second material, which is a non-flexible material, respectively, and then pressing and stirring the first material and the second material respectively for well mix;
pressing the first material and the second material respectively to form a first material piece and a second material piece;
stacking the first material piece and the second material piece to form a stack;
vulcanizing the stack in a high pressure and high temperature environment to bond the first material piece and the second material piece together firmly; and
releasing pressure on the stack to get a foaming member.

2. A method of making a foaming member with heterogeneous foaming layers, comprising the steps of:
adding a bonding medium, a foaming agent and an accelerator to a first material, which is a flexible material, and a second material, which is a non-flexible material, respectively, and then pressing and stirring the first material and the second material respectively for well mix;
pressing the first material and the second material respectively to form a first material piece and a second material piece;
stacking the first material piece and the second material piece and adding a bonding medium therebetween to form a stack;
vulcanizing the stack in a high pressure and high temperature environment to bond the first material piece and the second material piece together firmly; and
releasing pressure on the stack to get a foaming member.

3. The method as defined in claim 1, wherein the bonding medium is a foaming material that may be bonded with the first material and with the second material.

4. The method as defined in claim 2, wherein the bonding medium is a foaming material that may be bonded with the first material and with the second material.

5. The method as defined in claim 3, wherein the first material is thermoplastic rubber (TPR), and the second material is polyethylene (PE), and the bonding medium is thermoplastic elastomer (TPE).

6. The method as defined in claim 4, wherein the first material is thermoplastic rubber (TPR), and the second material is polyethylene (PE), and the bonding medium is thermoplastic elastomer (TPE).

7. The method as defined in claim 1, wherein the first material pieces and the second material pieces are stacked alternately to form the stack.

8. The method as defined in claim 2, wherein the first material pieces and the second material pieces are stacked alternately to form the stack.

9. The method as defined in claim 5, wherein the bonding medium is styrenic block copolymer (SBC) thermoplastic elastomer.

10. The method as defined in claim 6, wherein the bonding medium is styrenic block copolymer (SBC) thermoplastic elastomer.

11. The method as defined in claim 5, wherein the flexible material is selected from the group consisting of nature rubber (NB), polyurethane (PU), polyvinyl chloride (PVC), polyethylene (PE), and styrene-butadiene rubber (SBR).
